(19) United States
(12) Patent Application Publication
(10) Pub. No.: US 2006/0050511 A1
(43) Pub. Date: Mar. 9, 2006

(54) High intensity strobe light beam rodent repelling apparatus

(76) Inventors: Michael Joseph De Ginto, Kulpsville, PA (US); William Lester Earl, Norristown, PA (US)

Correspondence Address: Michael J. De Ginto, 1499-1 Sumneytown Pike, PO Box 1147, Kulpsville, PA, 19443, US

(21) Appl. No.: 10/936,385

(22) Filed: Sep. 8, 2004

(51) Int. Cl. F21S 6/00

(52) U.S. Cl. 362/257

(57) ABSTRACT

A high intensity strobe light beam rodent repelling apparatus, which produces an undesirable high intensity strobe light beam to rodents, such as squirrels, mice and bats. It is used to deter such rodents from trespassing within certain geographical location of the high intensity strobe light beam in attics and crawl spaces and other areas and used to deter rodents from occupying said spaces. The high intensity strobe light beam apparatus annoys the eyes of said rodent. The external stimulus produce a reversible unpleasant sensation to said rodents and will avoid returning to such area. It is virtually harmless and creates a sensation of dizziness. It is to be used indoors and in unoccupied spaces, and hangs from wood beams such as in attics, and crawl spaces, to a height, which is the most desirable height of high intensity strobe light beam spread to cover targeted area.

### BACKGROUND OF THE INVENTION

1. Field of Invention

The field of this invention is related to a high intensity light beam emitting apparatus and more particular to a high intensity light beam emitting apparatus detectable by rodents, in particular squirrels and bats, sensitive eyes to deter the rodents from trespassing and occupying property owners homes or businesses.

2. Description of the Prior Art

Owners of property have expressed an undesirable trespass and occupation of rodents, such as squirrels, mice and bats. These rodents, particularly squirrels, are known to deposit urine, feces, remove insulation, chew wires and cause fires.

Attempts have been made in the past to remove said rodents. The most popular way is to trap, use chemicals, natural odor, or sticky substances. However these known methods have been proven to be ineffective unless the rodent is killed. These methods tend to be very expensive and reoccurring for property owners. Cost of repairs and professional exterminators are expensive.

Another way in the past to deter trespassing or occupying property was by means of Ultrasonic sound. This method does not work on some rodents in particular, squirrels. These rodents have been known to form sound barriers with roofing insulation, or they just move to another part of the property. This method also employs batteries or electricity. Batteries tend not to last long and the property owner must change this device frequently. If electric Ultrasonic units are used they must be installed in specific and strategic locations as to use the sound for maximum effectiveness. This is an expensive solution.

### BRIEF SUMMARY OF THE INVENTION

The high intensity light beam emitting rodent repelling apparatus invention is designed to operate a high intensity intermittent light beam when the unit is plugged into a 120-volt socket. It produces a high intensity light, which disrupts the living cycle of rodents, in particular squirrels, mice and bats. The eyes of these pests are affected by the constant flashing and annoys these animals. The apparatus is mounted to a beam in unoccupied attic and crawl spaces. The unit is hung in a position to give maximum light coverage to an area. It is intended for indoor use only.

The primary goal of this apparatus is to deter, prevent trespassing and occupying at certain geographical location in homes or businesses. Thus preventing damage and unsanitary conditions caused by rodents. This is an inexpensive way to rid property owners of this reoccurring problem.

### BRIEF DESCRIPTION OF THE DRAWINGS

FIG. 1 is an exploded view of the high intensity light beam emitting apparatus of the present invention showing clearly the lens, lens housing, coupling, nipple, cover, gasket, wires, insulated wire connectors, ground screw, round box, connector, v-shaped wire, power supply cord, chain and tie-raps.

FIG. 2 is an assembled view of the high intensity light beam apparatus.

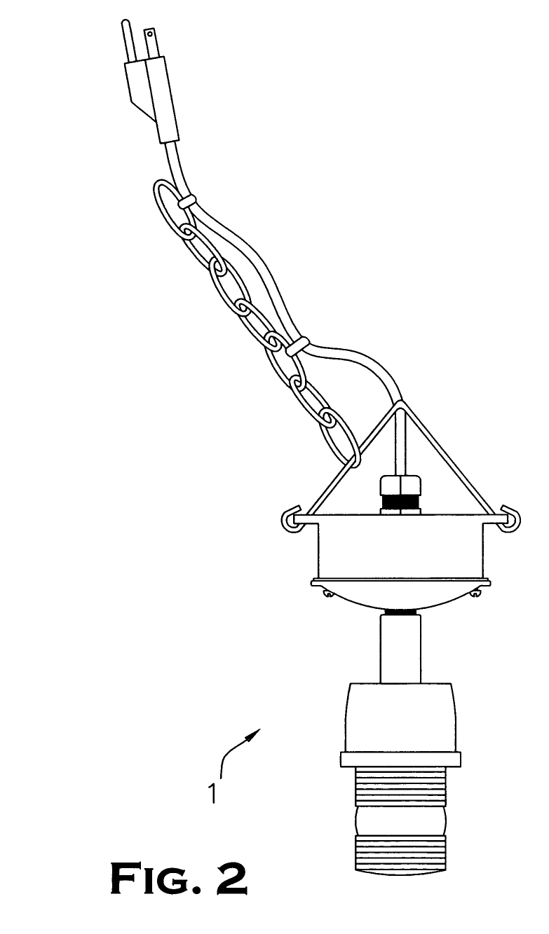

### DETAILED DESCRIPTION

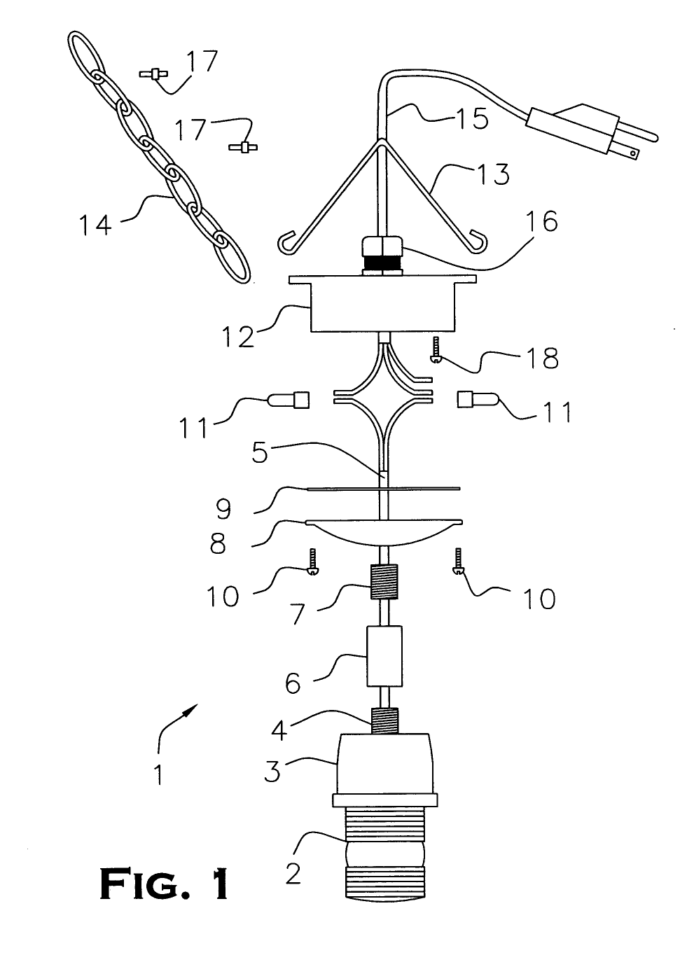

Referring particularly to the drawing in FIG. 1, all parts which are commercially available, there is shown, a high intensity strobe light beam fixture assembly consisting of; lens 2 which creates the beam light spread of approximately 30 feet by 30 feet, the lens housing 3 the pipe mount 4, the 2 wires 5, from the housing 3. The light spread is determined by the height of the placement on the coated chain 14, which is hung on a beam in an indoor unoccupied area of a users home or business.

The threaded coupling 6, is attached to the pipe mount 4. The threaded nipple 7, from coupling 6, is attached to round waterproof cover 8, with waterproof gasket 9. The Cover 8, waterproof gasket 9, have 2 holes for mounting screws 10.

2 wires 5, from housing 3, are feed through coupling 6, nipple 7, cover 8 and gasket 9.

A 12 foot long 3-wired power supply cord with 3-pronged plug 15, which powers the apparatus from the users 120 volt operating voltage receptacle, is fed through watertight connector 16, that is connected to round waterproof box 12, with ground screw 18.

2 wires of the 12 foot long 3-wired power supply cord with 3-pronged plug 15, are connected to 2 wires 5, of housing unit 3, by crimping 2 nylon insulated wire connectors 11. The green (3^{rd}) wire of 12 foot long 3-wired power supply cord with 3-pronged plug 15, is fastened to waterproof box 12, by ground screw 18.

Cover 8, waterproof gasket 9, is attached to the waterproof box 12, by 2 screws 10, The v-shaped galvanized wire 13, is attached through holes of flanges of the waterproof box 12. The coated chain 14, is fed through the v-shaped galvanized wire 13, tie raps 17, are fasten the 12 foot long 3-wire power supply cord with 3-pronged plug 15, to the coated chain 14.

It is understood that the units 12 foot long 3-wired power supply cord with 3-pronged plug 15, will be plugged into the users receptacle with an operating voltage of 120 volts. It is to be used in an indoor, unoccupied area such as an attic or crawl space. When the units 12 foot long 3-wired power supply cord with 3-pronged plug 15, is plugged into a 120 volt receptacle the unit will continuously flash a high intensity beam light for 10,000 hours. There is an option for the user to turn the unit off by means of an installed 120-volt electrical switch. This apparatus is a portable unit.

### REFERENCES CITED

### U.S. Patent Documents

| | | | |
|---|---|---|---|
| 5214411 | May 1993 | Herbruck | 367/139. |
| 3517226 | June 1970 | Jones, Sr | 367/139. |
| 4658386 | April 1987 | Morris | 367/139. |
| 4689776 | August 1987 | Thorndyke et al | 367/139. |
| 5015994 | May 1991 | Hoberman et al | 340/567. |

We claim:

1. A high intensity strobe light beam emitting apparatus comprising:
an electronic high intensity strobe light beam emitting an intermittent light beam housed in a removable clear, round prismatic lens the lens is threaded onto the housing. The apparatus has 2 wires and is powered by 120 Volts Alternating Current.
the housing has a threaded pipe mount, which is connected to a threaded coupling that has a threaded nipple attached. the threaded nipple from the coupling is threaded into a round waterproof cover that has a waterproof gasket.
the cover and waterproof gasket have two screw holes for mounting.
the 2 wires from the housing are feed through a coupling, nipple and cover. a 3 wired, 12 ft. power supply cord with 3-pronged plug is fed through a watertight connector, which is connected to the round waterproof box with ground screw
nylon insulated wire connectors are used to attach the 3-wired power supply cord to the 2 wires from the housing unit. The 3^{rd} (green wire) of the power supply cord is attached to the ground screw of the waterproof box the cover and waterproof gasket is attached to the round waterproof box by means of 2 screws. the waterproof round box has two flanges with holes.
a V-shaped galvanized wire is attached through the holes of the flanges of the waterproof box. the coated chain is fed through the V-shaped wire. tie raps are used to attach the power supply cord to the coated galvanized chain.

2. The apparatus as defined in claim 1 wherein:
with said high intensity strobe light beam in any position produces a high intensity strobe intermittent beam that produces a field of bright light in a circular pattern of approximately 900 square feet.
